(19) United States
(12) Patent Application Publication
(10) Pub. No.: US 2005/0075856 A1
(43) Pub. Date: Apr. 7, 2005

(54) Data migration using SMS simulator

(75) Inventors: Daniel Wozniak, St. Charles, IL (US); Mikhail L. Voldman, Northbrook, IL (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/677,133

(22) Filed: Oct. 1, 2003

(51) Int. Cl. G06F 9/45

(52) U.S. Cl. 703/22

(57) ABSTRACT

Migration to a service management system (SMS) is facilitated using an SMS simulator. Each of a plurality of provisioning requests is directed to the SMS simulator rather than the SMS. For each of a plurality of syntactically correct requests, the SMS simulator assigns a provisioning component identifier associated with the request, stores a command associated with the request and its associated provisioning component identifier in a transaction file, and sends a provisioning response based on the request. The requests in the transaction file are replayed to provision the SMS.

### BACKGROUND OF THE INVENTION

1. Field of the Disclosure

The present disclosure relates to methods and systems for migrating data from one service management system (SMS) to another SMS.

2. Description of the Related Art

A typical migration method comprises creating a utility to transfer and convert data from one SMS platform to another SMS platform in a flash-cut mode. The method comprises two major steps: a first step to extract data from one SMS, and a second step to load the data to the other SMS to bring the two SMSs in sync. During the time to perform the migration, which may take one or more weeks, service is interrupted to customers served by the SMS and new orders are not processed by the SMS. This provides that the data remains static over the time to perform the migration.

### BRIEF DESCRIPTION OF THE DRAWINGS

The present disclosure is pointed out with particularity in the appended claims. However, other features are described in the following detailed description in conjunction with the accompanying drawing in which:

FIG. 1 is a schematic diagram of an embodiment of a system for SMS data migration;

FIG. 2 is a flow chart of a method of SMS data migration;

FIG. 3 shows an example of a file format for a transaction file;

FIGS. 4(A-B) are schematic diagrams of a state of the system after closing the transaction file and opening a new transaction file;

FIG. 5 shows an example of a replay log file;

FIG. 6 shows a format for logging an unsuccessfully provisioned request; and

FIG. 7 shows an embodiment of a Provisioning Platform Item table of data items.

### DETAILED DESCRIPTION OF THE PREFERRED EMBODIMENTS

Embodiments of the present disclosure provide a progressive migration method for transferring and converting data to another SMS platform. During a period that extracted data is loaded to a target SMS, new orders are served without interruption. An SMS simulator buffers the new orders by recording data associated with the new orders. The SMS simulator periodically and/or selectively replays the buffered new orders into the target SMS. When no new orders are made within a replay time period, the target SMS is fully synchronized with the source SMS without interruption in service to both existing and new customers. The progressive migration method allows a telecommunication service provider to run in a dual-provisioning mode, wherein two SMS platforms run in parallel. After full migration, the target SMS can replace the source SMS.

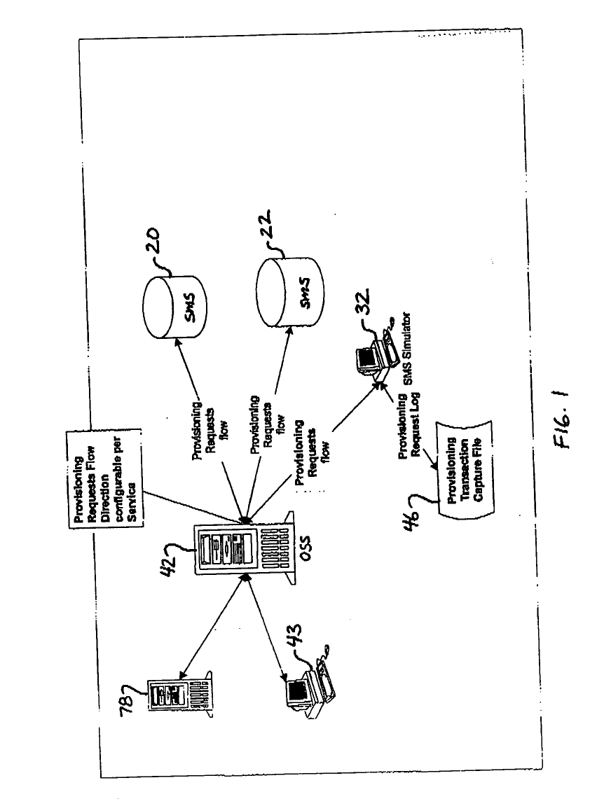

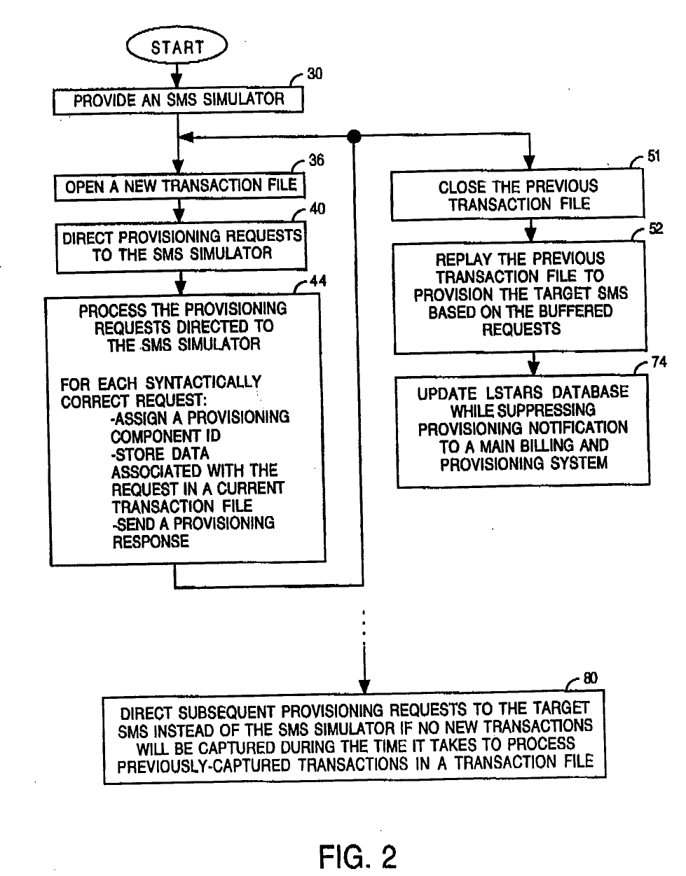

Embodiments of the present disclosure are described with reference to FIG. 1, which is a schematic diagram of an embodiment of a system for SMS data migration, and FIG. 2, which is a flow chart of a method of SMS data migration. The system comprises a source SMS 20 that serves customers of a telecommunication service provider, and a target SMS 22 which is to be synchronized with the source SMS 20. The two SMSs 20 and 22 may have different platforms. For example, the source SMS 20 may have a NORTEL Service Builder™ platform and the target SMS 22 may have an ALCATEL Infusion™ IN-platform. Those having ordinary skill will recognize that the present disclosure is not limited to the aforementioned two particular SMS platforms.

As indicated by block 30, the method comprises providing an SMS simulator 32. The SMS simulator 32 executes a replay utility to record and play back all the data generated during a migration period, hence providing the capability to capture provisioning changes while data is being loaded into the target SMS 22.

In one embodiment, the SMS simulator 32 is implemented using a version of XITAMI™ Web Server software running on a Microsoft® Windows NT computer. The server comprises two identical Win32 executables to perform SMS simulation and functionality to capture eXtensible Markup Language (XML) Application Program Interface (API) commands. The two executables are installed in a ProvOrder folder under a Xitami home directory in a file system of the computer with Common Gateway Interface (CGI) style interface to Xitami. The single program binary is duplicated in two executables for target SMS interface Unified Resource Identifier (URI) compliance. It is noted that in alternative embodiments, the SMS simulator 32 may be embodied as a general CGI application using alternative Web server platforms other than XITAMI™.

As indicated by block 36, the SMS simulator 32 opens a transaction file to act as a provisioning transaction capture buffer. The transaction file includes successfully provisioned component commands together with provisioning component IDs assigned by the SMS simulator 32. For example, the commands may comprise ALCATEL API commands. The transaction file is used for replaying captured transactions to the platform of the target SMS 22.

As indicated by block 40, the method comprises directing each of a plurality of provisioning requests to the SMS simulator 32. An Operating Support System (OSS) 42 which performs a middleware application between a main billing and provisioning system 78 and the SMSs performs this act. The OSS 42 configures an SMS server Internet Protocol (IP) address used by clients of the target SMS 22 to an IP address of the SMS simulator 32. The SMS server IP address can be configured individually per provisioning service, e.g. Number Translation Services (NTS), One-Plus Services (OPS) or Virtual Private Network (VPN) services. In one embodiment, the server IP address is set per provisioning service using the following UNIX environmental variables in the OSS 42: LDS_SMS_SERVER_IP_NTS, LDS_SMS_SERVER_IP_OPS, AND LDS_SMS_SERVER_IP_VPN. Preferably, all XML API provisioning transaction flows are redirected to the SMS simulator 32 for capture and future replay to the target SMS 22. The OSS 42 has a graphical user interface (GUI) 43 to facilitate user interaction.

As indicated by block 44, the method comprises processing the provisioning requests redirected to the SMS simulator 32. The SMS simulator 32 determines if each redirected provisioning request is syntactically correct. For each syntactically-correct provisioning request, the SMS simulator 32 assigns a provisioning component identifier (ID) associated with the request, stores a command associated with the request and its associated provisioning component ID in a transaction file 46, and sends a provisioning response based on the request.

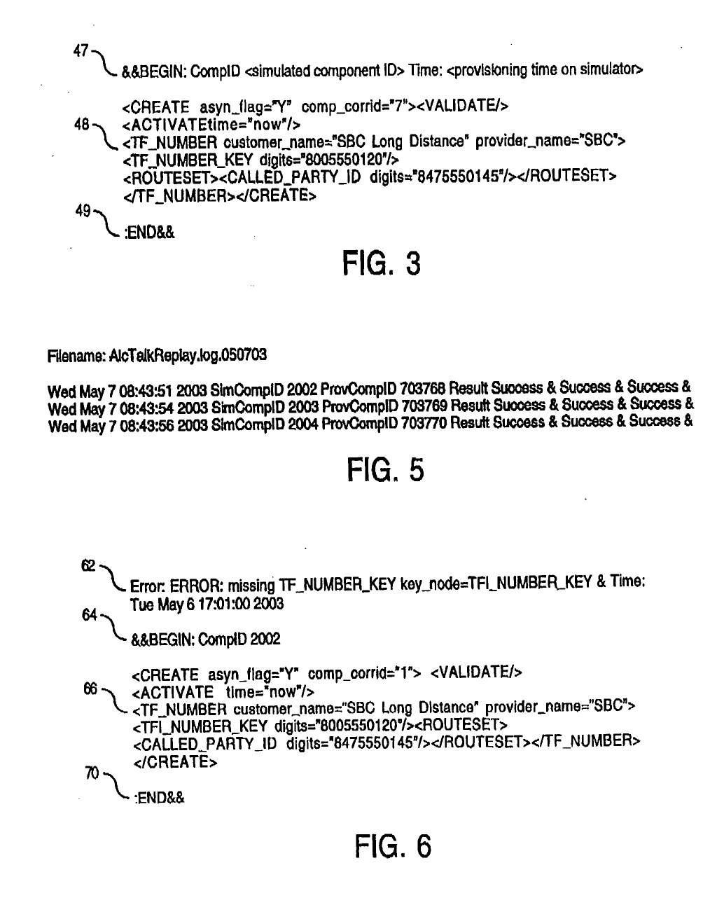

FIG. 3 shows an example of an XML capture file format for the transaction file 46. The example is of a captured ALCATEL SMS XML CREATE command. The transaction file 46 comprises a start tag command 47, a CREATE command 48, and an end tag 49. In one embodiment, the transaction file 46 is named xml_req.log and located in the ProvOrder folder.

Referring back to FIGS. 1 and 2, the provisioning response comprises a provisioning XML API response with a success code if the XML request is syntactically correct and the input command is successfully captured. If the request is not syntactically correct and/or the input command is unsuccessfully captured, the SMS simulator 32 sends a provisioning response with an error code.

At a point in time, the SMS simulator 32 closes the transaction file 46 (as indicated by block 51) and opens a new transaction file 50 (as indicated by block 36). The SMS simulator 32 closes the transaction file 46 and opens the new transaction file 50 either in response to an operator command, at a predetermined time, or at a predetermined time interval from a previous event. FIGS. 4(A-B) are schematic diagrams of a state of the system after closing the transaction file 46 and opening the transaction file 50.

As indicated by block 52, the method comprises replaying the transaction file 46 to provision target SMS 22 based on the requests. The transaction file 46 is submitted to a processor 54 which executes a UNIX-based replay utility to provision the target SMS 22. In one embodiment, the replay utility is implemented as a command line interface (CLI) utility that supports the following CLI command set:

connect <IP address>: to open TCP connection;
ip <IP address>: to set server IP address;
replay <file name>: to replay a capture file;
@ <file name>: to send file query;
login: to open SMS provisioning session; and
quit: to quit.

For capture replay, only one command should be used: replay <file name>, where <file name> is the name of the file captured by the SMS simulator 32. To run the replay utility in batch mode, the following UNIX shell command can be issued: alctalk replay xml_req.log. In one embodiment, the replay utility requires the following UNIX environment variables to be set: LDS_LOG_DIRECTORY, ENV_SMS_LOGIN_ID, ENV_SMS_LOGIN_PASSWORD, ENV_SMS_IP_ADDRESS and ENV_SMS_PORT_NUMBER.

At replay time, an actual response of the target SMS 22 is compared with a simulated response of the SMS simulator 32. If the actual response and the simulated response for a transaction are the same, the provisioning is deemed successful for the transaction. If there are any discrepancies between the actual response and the simulated response for a transaction, the provisioning is deemed unsuccessful for the transaction.

The period of time for the Update processor 54 to replay the transaction file 46 is significantly less than the actual provisioning time because the replay procedure is: executed in batch and not in an ad-hoc manner; does not utilize a database access for information retrieval; and uses pre-built XML for its API commands.

For a duration of the replay period, a replay log file 56 and a replay error file 60 are created by the replay processor 54. The replay log file 56 is to include information about successfully replayed provisioning transactions. The replay log file 56 includes a mapping between a simulated component ID and an actual component ID, an actual provisioning time, and provisioning result text. This file 56 is used in a subsequent database updating act.

The replay log file 56 may have a file name such as AlcTalkReplay.log.MMDDYY where MMDDYY is the month/day/year of that the file was created. In one embodiment, successfully provisioned requests are logged in the following format: day month time year SimCompID <Simulated COMP.ID> ProvCompID <Alcatel SMS COMP.ID><Result Text>. FIG. 5 shows an example of a replay log file 56 created on May 7, 2003.

The replay error file 60 is to include information about errors during replay provisioning requests, such as the aforementioned discrepancies in unsuccessfully provisioned requests. The replay error file 60 is created in a format suitable for editing by a human operator to perform corrective action. In one embodiment, the format comprises an XML format. The format of the replay error file 60 also facilitates resubmission. Thus, after editing by the human operator when a root cause of the provisioning error is determined, the replay error file 60 can be replayed to the target SMS 22.

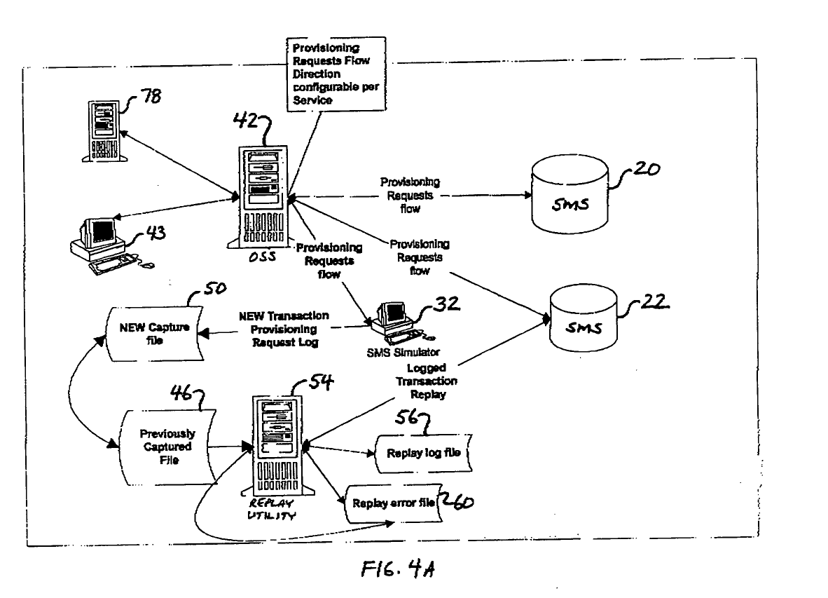

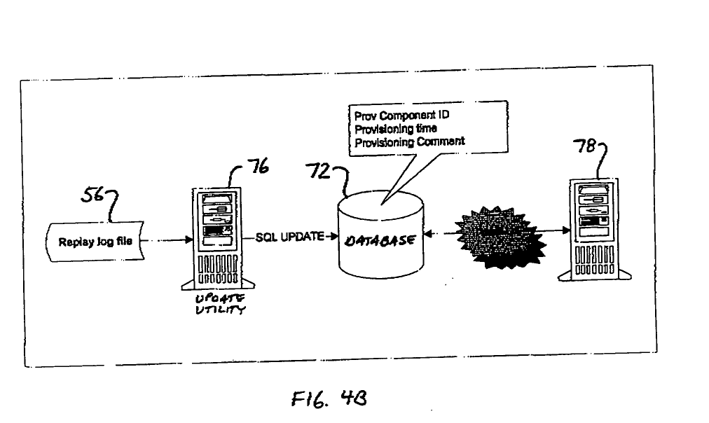

The replay error file 60 may have a file name such as AlcTalkError.log.MMDDYY where MMDDYY is the month/day/year of that the file was created. In one embodiment, every unsuccessfully provisioned request is logged in a format shown in FIG. 6. The format comprises a provisioning error description 62, a replay begin tag 64, command text of an unsuccessful request 66, and an replay end tag 70.

Reference is now made back to FIGS. 2 and 3. Simultaneous with replaying the transaction file 46, subsequent provisioning requests are redirected to and processed by the SMS simulator 32 as described with reference to blocks 40 and 44. Thus, for each syntactically-correct provisioning request, the SMS simulator 32 assigns a provisioning component ID associated with the subsequent request, stores a command associated with the subsequent request and its associated provisioning component ID in the transaction file 50, and sends a provisioning response based on the subsequent request.

After replaying the transaction file 46, an act of updating a database 72 based on the replay log file 56 is performed as indicated by block 74. In this act, information generated by the SMS simulator 32 during data capture is replaced with actual provisioning information. This act may comprise replacing the component ID of the SMS simulator 32 with the component ID of the target SMS 22, replacing the SMS-simulator-generated provisioning time information with an actual time that the target SMS 22 is provisioned, and replacing provisioning comments. In one embodiment, a processor 76 executes an update utility comprising a UNIX shell script that uses the replay log file 56 to update the database 72. It is noted that the replay processor 54 and the update processor 76 may be embodied by the same processor on the same computer, or each may be embodied by a separate computer.

The UNIX shell command that initiates updating the database 72 may comprise: alcupdate <provisioning log file name>. This script invokes an ORACLE Structured Query Language (SQL) utility to load the data into the database 72. The SQL utility reads a set of text data in a fixed-width columnar format.

The SQL utility causes extraction of a provisioned item ID, a provision record ID and a Service Management Interface (SMI) comment from the replay log file 56 to update a Provisioning Platform Item table of data items. It is noted that alternative column positions may be used in other embodiments.

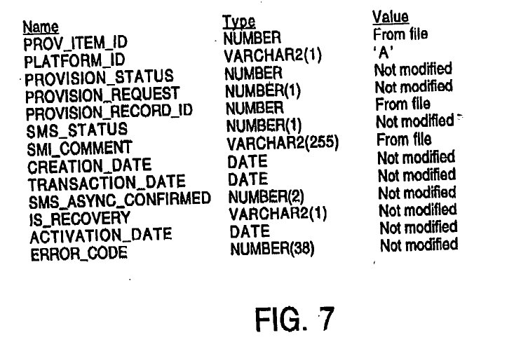

FIG. 7 shows an embodiment of the Provisioning Platform Item table of data items. The data items comprise a provisioned item ID, a platform ID, a provision status, a provision request, a provision record ID, an SMS status, an SMI comment, a creation date, a transaction date, an SMS async confirmed number, an item to indicate if a crash recovery is to be performed, an activation date, and an error code. Only the provisioned item ID, the platform ID, the provision record ID, and the SMI comment are updated by the SQL utility.

Referring back to FIG. 2, provisioning notification is suppressed to the main billing and provisioning system 78, such as one available from Telegence™, during the updating act in block 74. A TLD Notified flag in the provisioning information table is left unaffected by this data load to make sure that the system 78 is not notified of the data change.

At another point in time, the transaction file 50 is closed, another transaction file is opened, and the transaction file 50 is replayed for provisioning the target SMS 22. In one embodiment, each transaction file is nominally open for a predetermined time period of about one day or 24 hours. Thus, the transaction file 50 may be replayed the predetermined time period (e.g. about one day) after replaying the transaction file 46.

The process is repeated until no new transactions will be captured during the time it takes to process previously-captured transactions in the transaction file. Thereafter, subsequent provisioning requests are directed to the target SMS 22 instead of the SMS simulator 32, as indicated by block 80.

Those having ordinary skill will recognize that the herein-disclosed computer-implemented acts can be directed by computer-readable program code stored by a computer-readable medium. Examples of the computer-readable medium include, but are not limited to, a magnetic medium such as a hard disk or a floppy disk, an optical medium such as an optical disk (e.g. a CD or a DVD), or an electronic medium such as an electronic memory (e.g. a computer's internal memory or a removable memory such as a memory card). The herein-disclosed databases and files can be embodied by computer-readable media having computer-readable data stored thereon.

It will be apparent to those skilled in the art that the disclosed inventions may be modified in numerous ways and may assume many embodiments other than the preferred forms specifically set out and described herein.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method of migrating to a service management system (SMS), the method comprising:
providing an SMS simulator;
directing each of a plurality of provisioning requests to the SMS simulator instead of the SMS;
for each of a plurality of syntactically correct requests of the provisioning requests, using the SMS simulator to:
assign a provisioning component identifier associated with the request;
store a command associated with the request and its associated provisioning component identifier in a first transaction file; and
send a provisioning response based on the request; and
replaying the requests in the first transaction file to provision the SMS.

2. The method of claim 1 further comprising:
directing subsequent provisioning requests to the SMS instead of to the SMS simulator upon determining that no subsequent provisioning requests are made within a transaction-file-replay time period.

3. The method of claim 1 further comprising:
replacing SMS-simulator-generated provisioning information in a database with provisioning information for the SMS.

4. The method of claim 3 wherein said replacing comprises replacing the SMS-simulator-generated component identifiers in the database with a provisioning component identifier of the SMS.

5. The method of claim 3 wherein said replacing comprises replacing SMS-simulator-generated provisioning time information with provisioning time information for the SMS.

6. The method of claim 3 further comprising:
suppressing provisioning notification to a main billing and provisioning system during said replacing.

7. The method of claim 1 further comprising, while replaying the first transaction file:
directing a subsequent provisioning request to the SMS simulator; and
using the SMS simulator to:
assign a provisioning component identifier associated with the subsequent provisioning request;
store a command associated with the subsequent provisioning request and its associated provisioning component identifier in a second transaction file; and
send a provisioning response based on the subsequent provisioning request.

8. The method of claim 7 further comprising:
replaying the subsequent provisioning request in the second transaction file to provision the SMS.

9. The method of claim 8 wherein said replaying the second transaction file is performed a predetermined time period after said replaying the first transaction file.

10. The method of claim 9 wherein the predetermined time period is about one day.

11. A system for migrating to a service management system (SMS), the system comprising:
an SMS simulator;
a network element to redirect each of a plurality of provisioning requests to the SMS simulator instead of the SMS;
wherein for each of a plurality of requests of the provisioning requests, the SMS simulator is to:
assign a provisioning component identifier associated with the request;
store a command associated with the request and its associated provisioning component identifier in a first transaction file; and
send a provisioning response based on the request; and
a first utility to replay the requests in the first transaction file to provision the SMS.

12. The system of claim 11 wherein the network element is to direct subsequent provisioning requests to the SMS instead of the SMS simulator upon determining that no subsequent provisioning requests are made within a transaction-file-replay time period, and wherein each of the plurality of requests are syntactically correct.

13. The system of claim 11 further comprising a second utility to replace SMS-simulator-generated provisioning information in a database with provisioning information for the SMS.

14. The system of claim 13 wherein the second utility is to replace the SMS-simulator-generated component identifiers in the database with a provisioning component identifier of the SMS.

15. The system of claim 13 wherein the second utility is to replace SMS-simulator-generated provisioning time information with actual provisioning time information for the SMS.

16. The system of claim 13 wherein provisioning notification is suppressed to a main billing and provisioning system when the SMS-simulator-generated provisioning information is replaced.

17. The system of claim 11 wherein, while the first utility replays the first transaction file, the network element is to direct a subsequent provisioning request to the SMS simulator, and the SMS simulator is to:
assign a provisioning component identifier associated with the subsequent provisioning request;
store a command associated with the subsequent provisioning request and its associated provisioning component identifier in a second transaction file; and
send a provisioning response based on the subsequent provisioning request.

18. The system of claim 17 wherein the first utility is to replay the subsequent provisioning request in the second transaction file to provision the SMS.

19. The system of claim 18 wherein the first utility replays the second transaction file a predetermined time period after replaying the first transaction file.

20. The system of claim 19 wherein the predetermined time period is about one day.
